(19) United States
(12) Patent Application Publication
(10) Pub. No.: US 2007/0286088 A1
(43) Pub. Date: Dec. 13, 2007

(54) Inspection Device For Physical Layer Module, Method Thereof, And Communication System Using The Same

(76) Inventors: Kyung-Yeol Sohn, Daejeon-city (KR); Youn-Ok Park, Daejeon-city (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/667,641

(22) PCT Filed: Oct. 26, 2005
(86) PCT No.: PCT/KR05/03574

§ 371 Date: May 11, 2007

(30) Foreign Application Priority Data
Nov. 16, 2004 (KR) 10-2004-0093569

(51) Int. Cl. H04L 12/26; H04L 12/46

(52) U.S. Cl. 370/242

(57) ABSTRACT

An inspection device of a physical layer module connected between a terminal transmitting an Internet Protocol (IP)-packet and a physical layer module, the inspection device including an interface transmitting/receiving the IP-packet; a destination MAC address analyzing unit analyzing a destination MAC address to which the IP-packet transmitted from the interface is to be transmitted; a physical layer-packet/physical layer-frame generator converting the IP-packet and generating a physical layer-frame with a control header and an error-detecting code attached; a physical layer-frame transceiving unit transmitting/receiving a physical layer-frame to/from the physical layer module; and an IP-packet generator receiving a physical layer-frame with a control header and an error-detecting code attached from the physical layer module, determining the physical layer module based on the control header and the error-detecting code, converting the physical layer-frame into an IP-packet, and transmitting the IP-packet to the interface.

### TECHNICAL FIELD

The present invention relates to an Internet Protocol (IP)-packet based communication system. More particularly, the present invention relates to an inspection device for inspecting a physical layer module and a method thereof, and an IP-packet based communication system using the same.

### BACKGROUND ART

In general, a base station or a mobile phone of a wireless communication system based on wideband code division multiple access (CDMA) or orthogonal frequency division multiplexing access (OFDMA) requires an additional inspection device to inspect a physical layer module. For example, the inspection device includes an auxiliary logic formed by a modem Application Specific Integrated Circuit (ASIC) or a modem Field Programmable Gate Array (FPGA), and a digital signaling processor (DSP) assisting the auxiliary logic. When the inspection device is connected to a test device as an object of the inspection device, a register or memory of the modem ASIC (or modem FPGA) and the DSP are accessed and data is recorded. However, it is difficult to test hardware components of a physical layer using such an inspection device and a method thereof.

Therefore, a circuit (or, device) for applying an input signal to the physical layer module and a circuit (or, device) for examining validity of a signal output from the physical layer module are separately required for inspecting functions of the physical layer module. In addition, the reliability may decrease and inspection time may increase considering that inspection of the functions of the physical layer module is properly performed due to a generation condition of an input signal.

The above information disclosed in this Background section is only for enhancement of understanding of the background of the invention and therefore it may contain information that does not form the prior art that is already known in this country to a person of ordinary skill in the art.

### DISCLOSURE OF INVENTION

Technical Problem

The present invention has been made in an effort to provide an inspection device and a method thereof having advantages of inspecting an operation of a physical layer module by generating packets and frames according to a physical layer structure of a communication system from an IP-packet input through a network, to thereby stabilize the communication system and enhance quality.

Technical Solution

In one aspect of the present invention, an inspection device of a physical layer module connected between a terminal transmitting an Internet Protocol (IP)-packet and a physical layer module, the inspection device including an interface, a destination MAC address analyzing unit, a physical layer-packet/physical layer-frame generator, a physical layer-frame transceiving unit, and an IP-packet generator. The interface transmits and receives the IP-packet. The destination MAC address analyzes unit analyzing a destination MAC address to which the IP-packet transmitted from the interface is to be transmitted. The physical layer-packet/physical layer-frame generator converts the IP-packet and generates a physical layer-frame with a control header and an error-detecting code attached. The physical layer-frame transceiving unit transmits and receives a physical layer-frame to/from the physical layer module. The IP-packet generator receives a physical layer-frame with a control header and an error-detecting code attached from the physical layer module, determines the physical layer module based on the control header and the error-detecting code, converting the physical layer-frame into an IP-packet, and transmits the IP-packet to the interface.

The inspection device is connected to the terminal through a network.

The inspection device further includes a controller initializing the inspection device, setting and storing control information containing a physical layer transmission protocol, and transmitting the physical layer transmission protocol to a physical layer-packet/physical layer-frame generator and the IP-packet generator. The physical layer-packet/frame generator generates a physical layer-packet to be appropriate to a physical layer by assembling/disassembling the IP-packet based on the control in-formation stored in the controller, and generating the physical layer-frame by attaching the control header and error-detecting code to the physical layer-packet. The destination MAC address analyzing unit analyzes a MAC address of the IP-packet, and discards the IP-packet when the IP-packet is not expected to be transmitted using a physical layer.

The error-detecting code may be a cyclic redundancy check.

In another aspect of the present invention, a method used by an inspection device connected between a communication terminal and a physical layer module for inspecting the physical layer module is provided. The method includes a) receiving a physical layer-frame containing a control header and an error-detecting code from the physical layer module, b) inspecting an error in the physical layer module using the error-detecting code, c) analyzing the physical layer-frame and collecting valid data, and d) generating an IP-packet based on the collected valid data.

The method further includes 1) converting an IP-packet transmitted from the communication terminal, and generating a physical layer-frame with the control header and error-detecting code attached, and 2) transmitting the physical layer-frame through a physical layer. In 1), a physical layer-packet is generated by assembling/disassembling the IP-packet, the control header and error-detecting code are attached to the physical layer-packet and the physical layer-frame according to a physical layer transmission protocol is generated.

The IP-packet may be transmitted/received through a network.

In still another aspect of the present invention, a communication system transmitting/receiving data through a physical transmission medium is provided. The communication system includes a terminal, an inspection device, and a physical layer module. The terminal transmits and receives the data in a form of an Internet Protocol (IP)-packet. The inspection device converts the IP-packet transmitted from the terminal into a physical layer-frame based on a physical layer transmission protocol, and converts a received physical layer-frame into an IP-packet so as to be transmitted to a terminal. The physical layer module transmits a physical layer-frame transmitted from a physical transmission medium to the inspection device, and transmits a physical layer-frame generated by the inspection device to the physical transmission medium.

The terminal and the inspection device may be connected to each other through a network.

The inspection device includes an interface, a destination Medium Access Control (MAC) address analyzing unit, a physical layer-packet/physical layer-frame generator, a physical layer-frame transceiving unit, and an IP-packet generator. The interface transmits and receives the IP-packet to/from the terminal. The destination Medium Access Control (MAC) address analyzing unit analyzes a destination MAC address of an IP-packet transmitted from the interface. The physical layer-packet/physical layer-frame generator converts the IP-packet and generates a physical layer-frame with a control header and an error-detecting code attached. The physical layer-frame transceiving unit transmits and receives a physical layer-frame to/from the physical layer module. The IP-packet generator receives a physical layer frame with a control header and an error-detecting code attached from the physical layer module, inspects the physical layer module using the error-detecting code, converts the physical layer-frame into an IP-packet, and transmits the IP-packet to the interface.

The inspection device further includes a controller initializing the inspection device, setting and storing control information containing a physical layer transmission protocol, and transmitting the physical layer transmission protocol to the physical layer-packet/physical layer-frame generator and the IP-packet generator, and the physical layer-packet/frame generator generates a physical layer-packet to be appropriate to a physical layer by assembling/disassembling the IP-packet based on control information stored in the controller, and generating a physical layer-frame by attaching the control header and error-detecting code to the physical layer-packet.

Advantageous Effects

According to the embodiments of the present invention, the inspection device and the inspecting method may inspect the operation of the physical layer module responding to IP-packets functioning as various input sources in an IP-packet based client-server communication system.

In addition, the inspection device sets physical layer control information to thereby provide a flexible inspecting environment corresponding to various frame structures adapted to the physical layer.

### BRIEF DESCRIPTION OF THE DRAWINGS

FIG. 1 shows a schematic configuration of a communication system according to an exemplary embodiment of the present invention.

FIG. 2 shows a schematic configuration of an inspection device according to an exemplary embodiment of the present invention.

FIG. 3 is a flowchart showing a process performed by an inspection device according to an embodiment of the present invention.

FIG. 4 is a flowchart showing a process performed by an inspection device according to an embodiment of the present invention.

### BEST MODE FOR CARRYING OUT THE INVENTION

An embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, a physical layer is called “Layer 1” since it is typically located on the first layer in the communication protocol. Thus, the physical layer will be referred to as a “L1” throughout the specification.

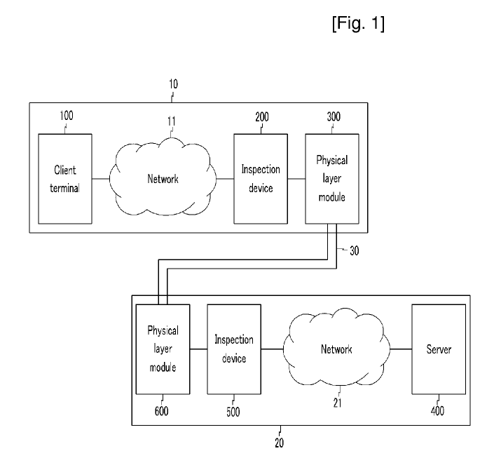

A communication system according to an exemplary embodiment of the present invention will now be described in more detail with reference to FIG. 1.

FIG. 1 shows a scheme of a communication system according to an exemplary embodiment of the present invention.

As shown in FIG. 1, the communication system includes a client system 10 and a server system 20. The client system 10 includes a client terminal 100, an inspection device 200, and a physical layer module 300, wherein the client terminal 100 and the inspection device are connected through a network 11. The server system 20 includes a server 400, an inspection device 500, and a physical layer module 600, wherein the server 400 and the inspection device 500 are connected through a network 21.

Herein, the networks 11 and 21 are communication networks, composing the Internet. Computers or terminals connected to a network exchange packets through the network, and the Internet is a group of networks connected through a bridge and/or router. Thus, the client terminal 100 and the inspection device 200 transmit/receive an IP-packet through the network 11, and the server 400 and the inspection device 500 transmits/receives an IP-packet through the network 21.

The client terminal 100 transmits a message in an Internet Protocol (IP)-packet to the inspection device 200 through the network 11, and receives the IP-packet message from the inspection device 200 through the network 11.

The inspection device 200 receives an IP-packet from the client terminal 100, and converts the IP-packet into an L1-frame so as to transmit the L1-frame to the physical layer module 300. In addition, the inspection device 200 converts the L1-frame transmitted from the physical layer module 300 into an IP-packet and transmits the IP-packet to the client terminal 100 through the network 11.

The physical layer module 300 transmits the L1-frame from the inspection device 200 through a physical transmission medium 30. The physical layer module 300 is connected to the physical layer module 600 through the physical transmission medium 30. Thus, the L1-frame transmitted from the client system 10 is transmitted to the server system 20 through the physical transmission medium 30. The physical transmission medium 30 may be wired or wireless.

The server 400 transmits a message in a form of an IP-packet to the inspection device 500 or receives the IP-packet message from the inspection device 500 through the network 21.

The inspection device 500 receives the IP-packet from the server 400, and converts the IP-packet message into an L1-frame so as to transmit the L1-frame to the physical layer module 600. In addition, the inspection device 500 converts the L1-frame transmitted from the server 400 into an IP-packet so as to transmit the IP-packet to the server 400 through the network 21.

The physical layer module 600 transmits the L1-frame to the physical layer module 300 or receives the L1-frame from the physical layer module 300 through the physical transmission medium 30.

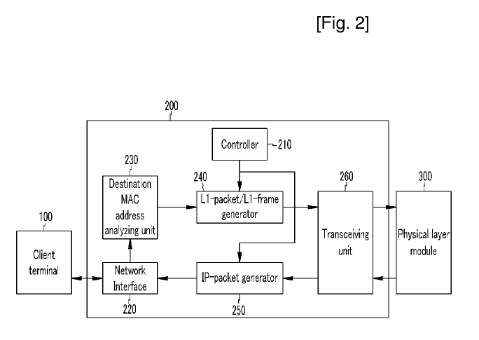

Configuration and operation of the inspection device 200 according to an exemplary embodiment of the present invention will now be described in more detail with reference to FIG. 2.

FIG. 2 shows a schematic configuration of the inspection device 200 according to an exemplary embodiment of the present invention.

Since the inspection device 200 and the inspection device 500 have the same configuration, only the inspection device 200 will be described in more detail.

As shown in FIG. 2, the inspection device 200 includes a controller 210, a network interface 220, a destination Medium Access Control (MAC) address analyzing unit 230, an L1-packet/L1-frame generator 240, an IP-packet generator 250, and a transceiving unit 260.

The controller 210 initializes the inspection device 200, and sets and stores control information bearing the size of an L1-packet, configuration of an L1-frame, and a physical layer transmission protocol for the physical transmission medium 30.

The network interface 220 transmits/receives a broadcasting or multicasting type of IP-packet, or an IP-packet data transmitted from the client terminal 100 or the server 400 through the networks 11 and 21.

The destination MAC address analyzing unit 230 analyzes a destination address to which a collected IP-packet is to be transmitted, and proceeds with the IP-packet transmission or discards the IP-packet depending on an analyzing result.

The L1-packet/L1-frame generator 240 converts an IP-packet input to the network interface 220 into an L1-frame based on the control information stored in the controller 210. In more detail, the L1-packet/L1-frame generator 240 disassembles the IP-packet and generates the L1-packet. A control header and an error-detecting code are appended to the L1-packet so that an L1-frame is generated. The control header includes information on identification numbers (IDs) indicating a sequence of disassembled parts when the IP-packet is disassembled. The error-detecting code is a code that can detects transmission errors of the physical layer module during transmission through the physical layer module. For example, a cyclic redundancy check (CRC), which is a cyclic binary code, is additionally attached to the L1-packet. As described, the control header and the error-detecting code are attached to the L1-packet so that the L1-frame is generated.

The IP-packet generator 250 converts the L1-packet/L1-frame transmitted from the physical layer module 300 into an IP-packet for transmission to the network interface 220 through the network 11.

The transceiving unit 260 transmits the L1-frame generated by the L1-packet/L1-frame generator 240 to the physical layer module 300, and transmits the L1-frame from the physical layer module 300 to the IP-packet generator 250.

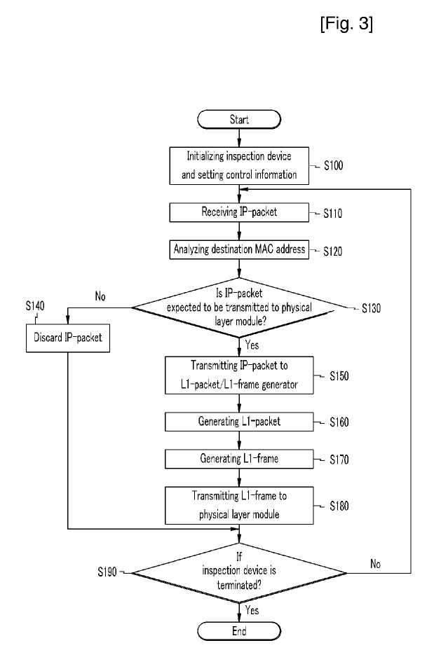

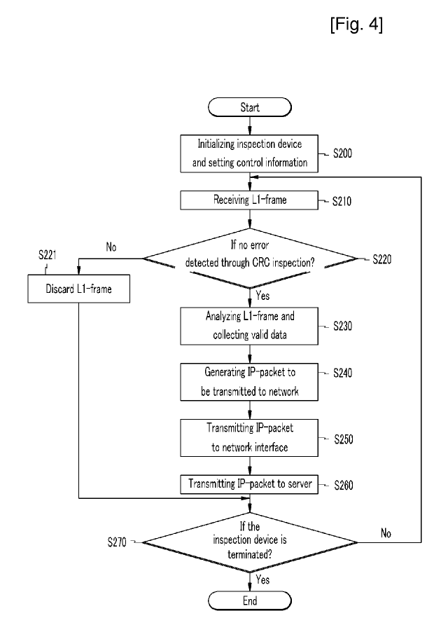

A method for inspecting the physical layer module 300 using an IP-packet will now be described in more detail with reference to FIG. 3 and FIG. 4.

FIG. 3 is a flowchart showing an IP-packet transmission process. As shown therein, an IP-packet is received at the network 11, converted into an L1-frame, and transmitted to the physical layer module 300. An IP-packet transmission process using the network 21 and the physical layer module 600 is the same as that of the process shown in FIG. 3, and thus a further detailed description will not be provided.

The inspection device 200 is initialized, and control information including the size of an IP-packet and configuration of an L1-packet to be transmitted to the physical layer module 300 is set in step S100.

The network interface 220 receives an IP-packet transmitted from the client terminal 100 through the network 11 in step S110.

A destination MAC address to which the received IP-packet is finally transmitted is analyzed in step S120.

As a result of analyzing the destination MAC address, it is determined whether the received IP-packet is expected to be transmitted to the physical layer module 300 through the physical transmission medium 30, in step S130. If the IP-packet is not expected to be transmitted through the physical transmission medium 30, for example if the IP-packet is expected to be transmitted to a device temporarily connected to the network 11, the IP-packet is discarded since it is no longer valid, in step S140.

When the IP-packet is expected to be transmitted through the physical transmission medium 30, the IP-packet is transmitted to the L1-packet/L1-frame generator 240, in step S150. The L1-packet/L1-frame generator 240 assembles/disassembles the IP-packet based on the control information stored in the controller 210, and generates an L1-packet, in step S160.

The L1-packet/L1-frame generator 240 attaches the control header and CRC to the L1-packet and generates an L1-frame appropriately structured to carry data through the physical transmission medium 30, in step S170.

The L1-frame containing the CRC is transmitted to the physical layer module 300 through the physical transmission medium 30 by a control signal generated from the physical layer module 300, in step S180.

Termination of the inspection device 200 is checked in step S190. If the inspection device 200 is terminated, this process is terminated. Otherwise, this process returns to step S110 to continue.

A process for transmitting an L1-frame to the inspection device 500 through the physical layer module 600 and inspecting the L1-frame will now be described.

FIG. 4 is a flowchart showing a process pf the inspection device 500. The inspection device 500 receives an L1-frame with a CTC attached from the physical layer module 600, converts the L1-frame into an IP-packet, and transmits the IP-packet to the server 400 as shown in FIG. 4.

The inspection device 500 is initialized, and control information including the size and configuration of an L1-packet to be transmitted to and received from the physical layer module 300 is set, in step S200.

The transceiving unit 260 of the inspection device 500 receives the L1-frame output from the physical layer module 600 in step S210.

When the received L1-frame is transmitted to the IP-packet generator 250, the IP-packet generator 250 checks whether the same cyclic redundancy code is obtained from the same calculation using the CRC attached to the L1-frame and inspects an error in the physical layer module 600, in step S220. If an error is detected, the L1-packet is discarded in step S221.

When no error is detected in the physical layer, the IP-packet generator 250 analyzes the received L1-frame based on the control information stored in the controller 210 and the control header attached to the L1-frame, and collects valid data, in step 230.

Since the collected valid data is provided in an assembled/disassembled form so as to be transmitted through the physical transmission medium 30, the IP-packet generator 250 generates an IP-packet containing the valid data so as transmit it through the network 21, in step S240.

The IP-packet generated by the IP-packet generator 250 is transmitted to the network interface 220 in step S250, and the network interface 220 transmits the IP-packet to the server 400 through the network 21 in step S260.

Termination of the inspection device 500 is checked in step S270, and this process is returned to S210 if the inspection device 500 is not terminated, in step S210. Otherwise, this process is terminated.

Accordingly, operation of the physical layer module is checked by detecting errors using the error-detecting code attached to the L1-frame.

As described, the inspection device and the inspecting method may inspect the operation of the physical layer module responding to IP-packets functioning as various input sources in an IP-packet based client-server communication system according to the embodiments of the present invention.

In addition, the inspection device sets physical layer control information to thereby provide a flexible inspecting environment corresponding to various frame structures adapted to the physical layer.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Throughout this specification and the claims which follow, unless explicitly described to the contrary, the word “comprise” or variations such as “comprises” or “comprising” will be understood to imply the inclusion of stated elements but not the exclusion of any other elements.

1. An inspection device of a physical layer module connected between a terminal transmitting an Internet Protocol (IP)-packet and a physical layer module, the inspection device comprising;
an interface transmitting/receiving the IP-packet;
a destination MAC address analyzing unit analyzing a destination MAC address to which the IP-packet transmitted from the interface is to be transmitted;
a physical layer-packet/physical layer-frame generator converting the IP-packet and generating a physical layer-frame with a control header and an error-detecting code attached;
a physical layer-frame transceiving unit transmitting/receiving a physical layer-frame to/from the physical layer module; and
an IP-packet generator receiving a physical layer-frame with a control header and an error-detecting code attached from the physical layer module, determining the physical layer module based on the control header and the error-detecting code, converting the physical layer-frame into an IP-packet, and transmitting the IP-packet to the interface.

2. The inspection device of claim 1, wherein the inspection device is connected to the terminal through a network.

3. The inspection device of claim 1, further comprising a controller initializing the inspection device, setting and storing control information containing a physical layer transmission protocol, and transmitting the physical layer transmission protocol to a physical layer-packet/physical layer-frame generator and the IP-packet generator.

4. The inspection device of claim 3, wherein the physical layer-packet/frame generator generates a physical layer-packet to be appropriate to a physical layer by assembling/disassembling the IP-packet based on the control information stored in the controller, and generating the physical layer-frame by attaching the control header and error-detecting code to the physical layer-packet.

5. The inspection device of claim 1, wherein the destination MAC address analyzing unit analyzes a MAC address of the IP-packet, and discards the IP-packet when the IP-packet is not expected to be transmitted using a physical layer.

6. The inspection device of claim 1, wherein the error-detecting code is a cyclic redundancy check.

7. A method used by an inspection device connected between a communication terminal and a physical layer module for inspecting the physical layer module, the method comprising:
a) receiving a physical layer-frame containing a control header and an error-detecting code from the physical layer module;
b) inspecting an error in the physical layer module using the error-detecting code;
c) analyzing the physical layer-frame and collecting valid data; and
d) generating an IP-packet based on the collected valid data.

8. The method of claim 7, further comprising
1) converting an IP-packet transmitted from the communication terminal, and generating a physical layer-frame with the control header and error-detecting code attached; and
2) transmitting the physical layer-frame through a physical layer.

9. The method of claim 8, wherein 1) comprises:
generating a physical layer-packet by assembling/disassembling the IP-packet; and
attaching the control header and error-detecting code to the physical layer-packet and generating the physical layer-frame according to a physical layer transmission protocol.

10. The method of claim 7, wherein the IP-packet is transmitted/received through a network.

11. The method of claim 7, wherein b) further comprises discarding the physical layer-frame when an error is detected in the physical layer module.

12. A communication system transmitting/receiving data through a physical transmission medium, the communication system comprising:
a terminal transmitting/receiving the data in a form of an Internet Protocol (IP)-packet;
an inspection device converting the IP-packet transmitted from the terminal into a physical layer-frame based on a physical layer transmission protocol, and converting a received physical layer-frame into an IP-packet so as to be transmitted to a terminal; and
a physical layer module transmitting a physical layer-frame transmitted from a physical transmission medium to the inspection device, and transmitting a physical layer-frame generated by the inspection device to the physical transmission medium.

13. The communication system of claim 12, wherein the terminal and the inspection device are connected to each other through a network.

14. The communication system of claim 12, wherein the inspection device comprises:
an interface transmitting/receiving the IP-packet to/from the terminal;
a destination Medium Access Control (MAC) address analyzing unit analyzing a destination MAC address of an IP-packet transmitted from the interface;
a physical layer-packet/physical layer-frame generator converting the IP-packet and generating a physical layer-frame with a control header and an error-detecting code attached;
a physical layer-frame transceiving unit transmitting/receiving a physical layer-frame to/from the physical layer module; and
an IP-packet generator receiving a physical layer frame with a control header and an error-detecting code attached from the physical layer module, inspecting the physical layer module using the error-detecting code, converting the physical layer-frame into an IP-packet, and transmitting the IP-packet to the interface.

15. The communication system of claim 14, wherein:
the inspection device further comprises a controller initializing the inspection device, setting and storing control information containing a physical layer transmission protocol, and transmitting the physical layer transmission protocol to the physical layer-packet/physical layer-frame generator and the IP-packet generator, and
the physical layer-packet/frame generator generates a physical layer-packet to be appropriate to a physical layer by assembling/disassembling the IP-packet based on control information stored in the controller, and generating a physical layer-frame by attaching the control header and error-detecting code to the physical layer-packet.
